(19) United States
(12) Patent Application Publication
(10) Pub. No.: US 2005/0269957 A1
(43) Pub. Date: Dec. 8, 2005

(54) Driving circuits, compensation circuits and signal compensation method for pixel of active organic electro-luminescence device

(76) Inventors: Hong-Ru Guo, Tainan (TW); Keng-Chu Lin, Tainan (TW); Chen-Chung Yang, Tainan (TW); Chia-Tin Chung, Tainan (TW)

Correspondence Address: TROP PRUNER & HU, PC, 8554 KATY FREEWAY, SUITE 100, HOUSTON, TX, 77024, US

(21) Appl. No.: 11/056,303

(22) Filed: Feb. 11, 2005

(30) Foreign Application Priority Data
Jun. 2, 2004 (TW) 93115754

(51) Int. Cl. G09G 3/10

(52) U.S. Cl. 315/169.3

(57) ABSTRACT

A driving circuit of a pixel of an active organic electro-luminescence device for driving an emitting device in the pixel of the active organic electro-luminescence device is provided. A voltage sensor is adapted for sensing the voltage of the emitting device and sending out the signal according to the voltage. A compensation unit is adapted for receiving the signal output from the voltage sensor. A compensating signal is sent to an emitting device driving unit for compensating the data signal input into the pixel of active organic electro-luminescence device so as to improve uniformity in the brightness of the active organic electro-luminescence device.

### BACKGROUND OF THE INVENTION

1. Field of the Invention

The present invention relates to driving circuits, compensation circuits and signal compensation methods for a pixel, and more particularly to driving circuits, compensation circuits and signal compensation methods for a pixel of an active organic electro-luminescence device (OELD).

2. Description of Related Art

As multi-media technology advances, a variety of semiconductor devices or display devices have been rapidly developed. As to displays, for example, flat panel displays, because of its advantages of high resolution, high space-effectiveness, low power consumption and non-radiation, the flat panel displays have become the main trend in this industry.

Flat panel displays include liquid crystal displays (LCDs), organic electro-luminescence displays, plasma display panels (PDPs) and so on. The organic electro-luminescence displays are array displays with emissive devices. Due to its wide-view angle, low manufacturing costs, high-speed response (about hundred times of liquid crystal displays), low power consumption, compatible application with direct current (DC) portable devices, large range of operational temperatures, slim sizes and light weights, the organic electro-luminescence displays are more suitable for multi-media communication than the others. The organic electro-luminescence displays are the promising next-generation displays.

The organic electro-luminescence displays, according to the driving methods, include active and passive organic electro-luminescence displays. The life span and the luminescent efficiency of the passive driving devices dramatically decay with the increase of sizes and resolution. Though the traditional organic electro-luminescence displays use low-end passive driving methods, the present organic electro-luminescence displays adopts active driving methods.

When a constant current is applied to drive the active organic electro-luminescence displays, the voltage of the internal emitting devices increase with time goes by, and the driving current derived from the driving circuit to the emitting devices, therefore, is reduced. This will cause the decay of the brightness of the emitting devices with time goes by. In other words, if OLED lightened a certain part of pixel for a long time, the emitting devices in the over turn-on pixels decay faster than the others. This phenomenon results in non-uniformity of the brightness of the organic electro-luminescence displays.

### SUMMARY OF THE INVENTION

Accordingly, the present invention is directed to a driving circuit of a pixel of an active organic electro-luminescence device. The driving circuit generates a compensation signal to compensate the data signal input to the pixel so as to improve uniformity in the brightness of the active organic electro-luminescence device.

The present invention is also directed to a signal compensation method of a pixel of an active organic electro-luminescence device. The method compensates the driving current of the emitting device of the pixel so as to improve uniformity in the brightness of the active organic electro-luminescence device.

The present invention is also directed to a compensation circuit of a pixel of an active organic electro-luminescence device. The compensation circuit compensates the data signal input to the pixel so as to improve uniformity in the brightness of the active organic electro-luminescence device.

The present invention discloses a driving circuit of a pixel of an active organic electro-luminescence, the pixel of the active organic electro-luminescence device comprises an emitting device. The driving circuit of the pixel of the active organic electro-luminescence device comprises an emitting device driving unit, a voltage sensor and a compensation unit. The emitting device driving unit is coupled to the emitting device for driving the emitting device. One terminal of the voltage sensor is coupled between the emitting device driving unit and the emitting device so as to sense a voltage of the emitting device and output a signal according to the voltage. The compensation unit is coupled to the voltage sensor and the emitting device driving unit for receiving the signal output from the voltage sensor and outputting a compensation signal to the emitting device driving unit for compensating the data signal input to the pixel of the active organic electro-luminescence.

The present invention also discloses a compensation circuit of a pixel of an active organic electro-luminescence, the pixel of the active organic electro-luminescence device comprises an emitting device and an emitting device driving unit for driving the emitting device. The compensation circuit of a pixel of an active organic electro-luminescence comprises voltage sensor and compensation unit, wherein one terminal of the voltage sensor is coupled between the emitting device driving unit and the emitting device so as to sense a voltage of the emitting device and output a signal according to the voltage. The compensation unit is coupled to the voltage sensor and the emitting device driving unit for receiving the signal output from the voltage sensor and outputting a compensation signal to the emitting device driving unit for compensating the data signal input to the pixel of the active organic electro-luminescence.

According to an embodiment of the present invention, the emitting device driving unit comprises a data line, a scan line and a switch device. The extension direction of the scan line is different from that of the data line. It is preferred that they are orthogonal. The switch device is coupled to the scan line, the data line and the emitting device. In an embodiment of the present invention, the switch device comprises, for example, two transistors.

According to an embodiment of the present invention, the voltage sensor can be, for example, a transistor. The transistor comprises a gate, a drain and a source, the gate is coupled to the emitting device driving unit and the emitting device, a voltage is applied to the drain, and the source is coupled to the compensation unit.

According to an embodiment of the present invention, the compensation unit comprises a memory device and a comparison unit. The memory device stores a first driving signal for driving the emitting device. The comparison unit is coupled to the memory device and the voltage sensor for receiving and comparing the first driving signal and the output signal of the voltage sensor, and outputting the compensation signal to the emitting device driving unit according to the comparison.

The present invention also discloses a signal compensation method for a pixel of an active organic electro-luminescence device, wherein the pixel of the active organic electro-luminescence device comprises an emitting device. The signal compensation method for the pixel of the active organic electro-luminescence device first activates the pixel of the active organic electro-luminescence device, and inputs an initial signal to the active organic electro-luminescence device. The method senses and records a first driving signal of the emitting device. The pixel of the active organic electro-luminescence device is then turned off. The method then re-activates the pixel of the active organic electro-luminescence device, and re-inputs the initial signal to the active organic electro-luminescence device. The method also senses and records a second driving signal of the emitting device. Next, the first driving signal and the second signal are compared, and a compensation signal is output according to the comparison. Thus, a data signal input to the pixel of the active organic electro-luminescence device is compensated by the compensation signal.

According to an embodiment of the present invention, the first driving signal and the second driving signal can be, for example, current signals. In another embodiment of the present invention, the first driving signal and the second driving signal can be, for example, voltage signals.

The present invention resolves the problem of the over loading of pixels which would adversely decrease the life span of the active organic electro-luminescence device. Hence, the uniformity in the brightness of the active organic electro-luminescence device is improved.

In index to make the aforementioned and other objects, features and advantages of the present invention understandable, a preferred embodiment accompanied with figures is described in detail below.

### BRIEF DESCRIPTION OF THE DRAWINGS

FIG. 1 is a circuit block diagram showing a driving circuit of a pixel of an organic electro-luminescence device according to an embodiment of the present invention.

FIG. 2 is a schematic drawing showing a driving circuit of a pixel of an organic electro-luminescence device according the embodiment of the present invention shown in FIG. 1.

FIG. 3 is a schematic drawing showing a driving circuit of a pixel of an organic electro-luminescence device according to another embodiment of the present invention.

FIG. 4 is a schematic drawing showing a driving circuit of a pixel of an organic electro-luminescence device according to another embodiment of the present invention.

FIG. 5 is a schematic drawing showing a driving circuit of a pixel of an organic electro-luminescence device according to another embodiment of the present invention.

FIG. 6 is a flowchart showing a signal compensation method for a pixel of an active organic electro-luminescence device according to an embodiment of the present invention.

### DESCRIPTION OF EMBODIMENTS

The present invention configured the voltage sensor and the compensation unit for sending out the compensation signal in the active organic electro-luminescence device so as to improve uniformity in the brightness of devices. Followings are the descriptions for single pixel of an active organic electro-luminescence device according to an embodiment of the present invention. One of the embodiments of the present invention can be used in any pixel of the active organic electro-luminescence device. Accordingly, one will know how to use the present invention to some specific or all pixels.

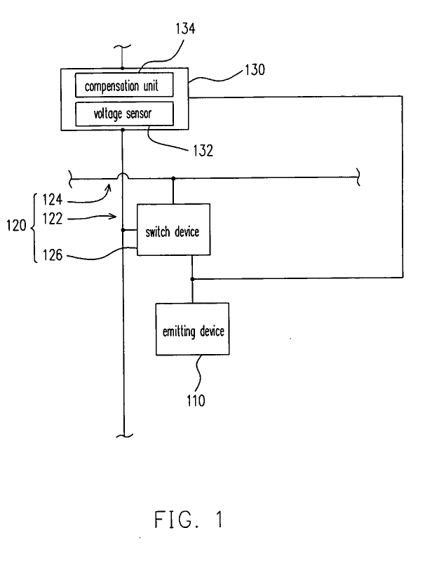

FIG. 1 is a circuit block diagram showing a driving circuit of a pixel of an organic electro-luminescence device according to an embodiment of the present invention. Referring to FIG. 1, the pixel of the organic electro-luminescence device comprises the emitting device driving unit 120 and the compensation circuit 130. The emitting device driving unit 120 is coupled to the emitting device 110. In this embodiment, the emitting device driving unit 120 comprises, for example, the data line 122, the scan line 124 and the switch device 126. The extension direction of the scan line 124 can be, for example, different from that of the data line 122. They can be, for example, orthogonal. The switch device 126 is coupled to the scan line 124 and the data line 122. One terminal of the compensation circuit 130 is coupled to the signal output terminal of the emitting device driving unit 120, i.e. the switch device 126, and the emitting device 110. Another terminal of the compensation circuit 130 is coupled to the signal input terminal, such as the data line 122, of the emitting device driving unit 120 for receiving the driving signal of the emitting device 110, and outputting the compensation signal to the emitting device driving unit 120.

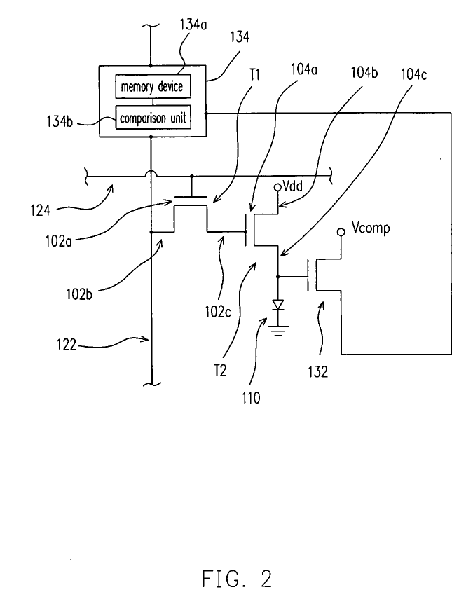

In this embodiment, the switch device 126 of the emitting device driving unit 120 comprises, for example, transistors T1 and T2. One skilled in the art will understand that the switch device 126 may comprise more than two transistors. The present invention is not limited to any specific or number of the transistors. The compensation circuit 130 comprises, for example, the voltage sensor 132 and the compensation unit 134. The emitting device 110 can be, for example, an organic electro-luminescence emitting diode as shown in FIG. 2. The gate 102a of the transistor T1 is coupled to the scan line 124, the source/drain 102b is coupled to the data line 122, and the source/drain 102c is coupled to the gate 104a of the transistor T2. In some embodiments, the transistor T2 can be, for example, a P-type transistor. A voltage V_{dd} is applied to the source/drain 104b of the transistor T2, and the source/drain 104c of the transistor T2 is coupled to the emitting device 110.

Referring to FIG. 2, the voltage sensor 132 is coupled to the emitting device 110 and the transistor T2 for sensing the voltage of the emitting device 110 and sending out a signal according to the voltage. The voltage sensor can be composed of, for example, a transistor. The gate of the transistor can be coupled to, for example, the emitting device 110 and the source/drain 104c of the transistor T2. The voltage V_{comp} is applied to the source/drain 104b of the transistor. The voltage V_{comp} is used to maintain the operational voltage of the transistor in the saturation region of an I-V curve. Hence, the drain current is more sensitive to the change of the gate voltage. One skilled in the art will know that the operational voltage of the transistor can be maintained in the linear region. The source of the transistor is coupled to the compensation circuit 130.

It should be noted that the sensitivity of the drain current corresponding to the gate voltage can be enhanced by modifying the size of the transistor of the voltage sensor 132. One skilled in the art will understand that the slope of the I-V curve of the drain current and the gate voltage is inverse proportional to the gate length, but proportional to the gate width. Hence, the transistor of the voltage sensor 132 can be a transistor, for example, with a short gate length and a wide gate width. The sensitivity of the drain current corresponding to the gate voltage is, therefore, enhanced.

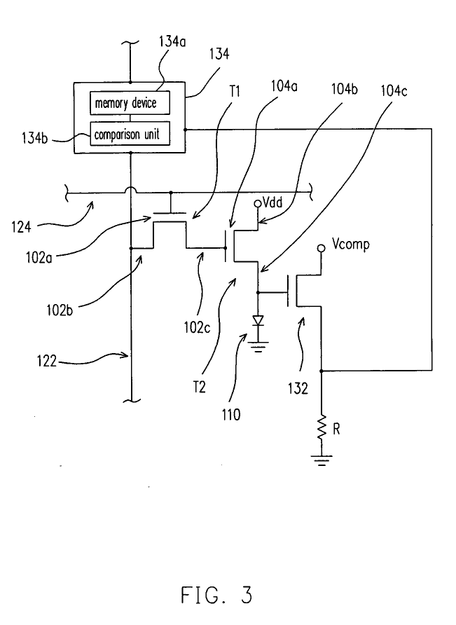

The compensation unit 134 can be, for example, coupled to the voltage sensor 132 and the data line 122 for receiving the signal output from the voltage sensor 132 and sending out the compensation signal to the data line 122 according to the signal to compensate the data signal input into the pixel of the active organic electro-luminescence device. In an embodiment of the present invention, the compensation unit 134 comprises, for example, the memory device 134a and the comparison unit 134b. The memory device 134a is coupled to the comparison unit 134b for recording the first driving signal of the emitting device 110. The comparison unit 134b is coupled to the voltage sensor 132 and the memory device 134a for receiving the second driving signal output from the voltage sensor 132. The comparison unit 134b then accesses the first driving signal stored in the memory device 134a to compare the first driving signal and the second driving signal. The compensation unit 134 then outputs the compensation signal to the data line 122 according to the comparison. The compensation signal can be determined, for example, by checking reference tables according to the comparison. The reference tables are stored, for example, in the memory device 134a. In an embodiment of the present invention, the comparison unit 134b can be, for example, a current comparator (not shown) for comparing the first driving signal and the second driving signal, which are sent out by currents. In another embodiment of the present invention, the comparison unit 134b can be, for example, a voltage comparator (not shown) for comparing the first driving signal and the second driving signal which are sent out by voltages. The resistor R (as shown in FIG. 3) can be coupled to the voltage sensor 132 and the compensation unit 134 for sensing the output voltage from the voltage sensor 132.

While a constant current is used to drive the driving circuit for the pixel of the active organic-luminescence device, the voltage sensor 132 senses the voltage of the source/drain 104c of the transistor T2. In this embodiment, the voltage represents the driving voltage for the emitting device 110. The first driving signal of the emitting device 110 is sent out to the compensation unit 134 according to the voltage, and stored in the memory device 134a. In an embodiment of the present invention, the voltage sensor can be composed, for example, a transistor. The first driving signal can be transformed, for example, from the drain current of the transistor.

After the pixel is turned on for a while, the voltage of the emitting device 110 rises. Hence, the voltage difference between the gate 104a and the source/drain 104c of the transistor T2 reduces. The voltage sensor 132 first senses the source/drain voltage 104c of the transistor T2, and sends out the second driving signal to the compensation unit 134 according to the voltage. The comparison unit 134b of the compensation unit 134 compares the second driving signal and the first driving signal stored in the memory device 134a, and sends out the compensation signal to the data line 122 according to the comparison. The voltage of the gate 104a of the transistor T2, therefore, rises and the drain current of the transistor T2 also increases. The driving current of the emitting diode 110 can be stabilized so as to maintain the brightness of the pixel.

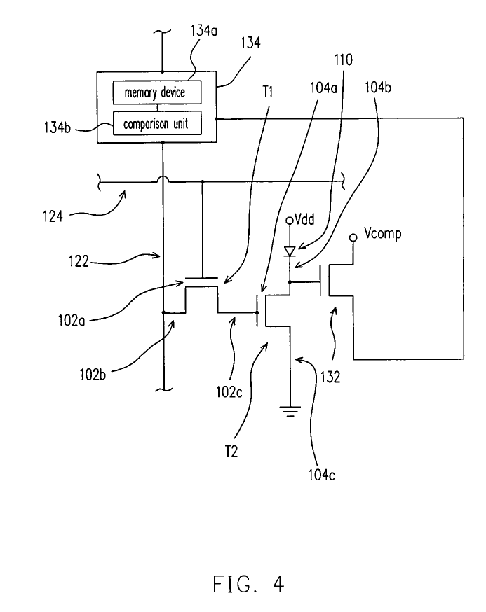

In an embodiment of the present invention, the switch device 126 and the emitting device 110 can be coupled in another way. Referring to FIG. 4, the source/drain 104b of the transistor T2 of the switch device 126 is coupled to the emitting device 110 and the voltage sensor 132. The voltage V_{dd} is applied to the emitting device 110 and the source/drain 104c of the transistor T2 is grounded.

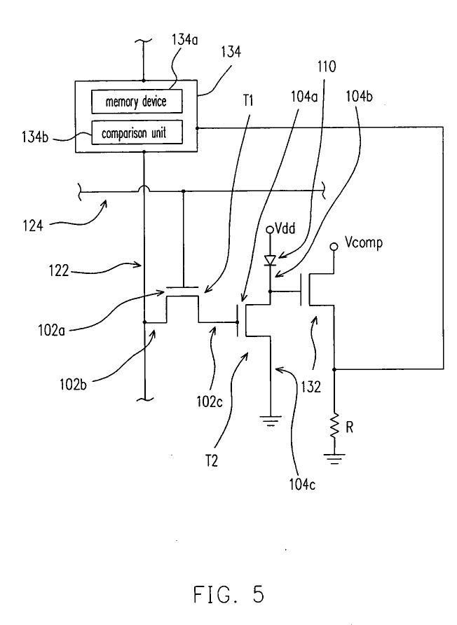

In this embodiment of the present invention, if the comparison unit 134b, for example, is a voltage comparator (not shown) for comparing the first driving signal and the second driving signal which are sent out by voltages, the resistor R can be coupled to the voltage sensor 132 and the compensation unit 134 for sensing the output voltage from the voltage sensor 132 as shown in FIG. 5.

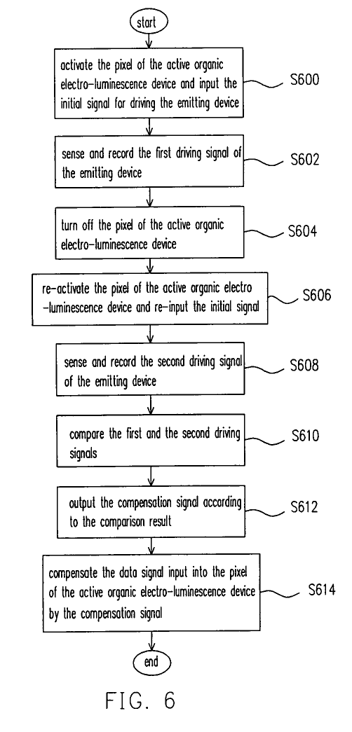

FIG. 6 is a flowchart showing a signal compensation method for a pixel of an active organic electro-luminescence device according to an embodiment of the present invention. Referring to FIG. 6, at step S600, the pixel of the active organic electro-luminescence device is activated, and the initial signal for driving the emitting device is input. At step S602, the first driving signal generated from the emitting device in response to the initial signal is sensed and recorded. At step S604, the pixel of the active organic electro-luminescence device is turned off. At step S606, the pixel of the active organic electro-luminescence device is re-activated, and the initial signal is re-input. At step S608, the second driving signal generated from the emitting device is sensed and recorded. At step S610, the first and second driving signals are compared so as to generate a comparison result. The first and second driving signals can be voltage signals or current signals. At step S612, the compensation signal is output according to the comparison result at step S610. At step S614, the data signal input into the pixel of the active organic electro-luminescence device is compensated by the compensation signal. Hence, as the voltage of the data signal increases and the driving current of the emitting device also increases.

According to an embodiment of the present invention, the voltage sensor is adapted for sensing the driving voltage of the emitting device. While the driving voltage of the emitting device increases with time goes by, the voltage sensor senses the change in the voltage and modifies the output current accordingly. The compensation unit is adapted for determining the change of the driving voltage for the emitting device and outputting the compensation signal to the emitting device driving unit according to the voltage change so as to increase the driving current of the emitting device. According to an embodiment of the present invention, the driving circuit and the compensation circuit are adapted for compensating the signals of the pixel of the active organic electro-luminescence device. Hence, the problem resulting from the over loading of pixels having a faster decay of life span than that of the others can be resolved. The uniformity in the brightness of the active organic electro-luminescence device is, therefore, improved.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A driving circuit for a pixel of an active organic electro-luminescence device, the pixel comprising an emitting device, the driving circuit comprising:
an emitting device driving unit, coupled to the emitting device, for driving the emitting device;
a voltage sensor, one terminal of the voltage sensor being coupled to the emitting device driving unit and the emitting device, for sensing a voltage of the emitting device and outputting a signal according to the voltage; and
a compensation unit, coupled to the voltage sensor and the emitting device driving unit, for receiving the signal output from the voltage sensor and sending out a compensation signal to the emitting device driving unit.

2. The driving circuit of a pixel of an active organic electro-luminescence device of claim 1, wherein the emitting device driving unit comprises:
a data line;
a scan line, wherein an extension direction of the scan line is different from that of the data line; and
a switch device, coupled to the data line, the scan line and the emitting device.

3. The driving circuit of a pixel of an active organic electro-luminescence device of claim 2, wherein the switch device comprises at least two transistors.

4. The driving circuit of a pixel of an active organic electro-luminescence device of claim 1, wherein the voltage sensor comprises a transistor, the transistor comprises a gate, a drain and a source, the gate is coupled to the emitting device driving unit and the emitting device, a voltage is applied to the drain, and the source is coupled to the compensation unit.

5. The driving circuit of a pixel of an active organic electro-luminescence device of claim 1, wherein the voltage sensor comprises a transistor, the transistor comprises a gate, a drain and a source, the gate is coupled to the emitting device driving unit and the emitting device, a voltage is applied to the source, and the drain is coupled to the compensation unit.

6. The driving circuit of a pixel of an active organic electro-luminescence device of claim 1, wherein the compensation unit comprises:
a memory device, for storing a first driving signal for driving the emitting device; and
a comparison unit, coupled to the memory device and the voltage sensor, for receiving and comparing the first driving signal and the output signal of the voltage sensor, and sending out the compensation signal to the emitting device driving unit according to the comparison.

7. The driving circuit of a pixel of an active organic electro-luminescence device of claim 6, wherein the comparison unit comprises a voltage comparator.

8. The driving circuit of a pixel of an active organic electro-luminescence device of claim 6, wherein the comparison unit comprises a current comparator.

9. A signal compensation method for a pixel of an active organic electro-luminescence device, the pixel comprising an emitting device, the method comprising:
activating the pixel of the active organic electro-luminescence device, and inputting an initial signal for driving the emitting device;
sensing and recording a first driving signal of the emitting device;
turning off the pixel of the active organic electro-luminescence device;
re-activating the pixel of the active organic electro-luminescence device, and re-inputting the initial signal for driving the emitting device;
sensing and recording a second driving signal of the emitting device;
comparing the first driving signal and the second driving signal, and sending out a compensation signal according to the comparison; and
compensating a data signal of the pixel of the active organic electro-luminescence device with the compensation signal.

10. The signal compensation method for a pixel of an active organic electro-luminescence device of claim 9, wherein the first driving signal and the second driving signal comprise voltage signals.

11. The signal compensation method for a pixel of an active organic electro-luminescence device of claim 9, wherein the first driving signal and the second driving signal comprise current signals.

12. A compensation circuit of a pixel of an active organic electro-luminescence device, the pixel comprising an emitting device and an emitting device driving unit, the emitting device driving unit driving the emitting device, the compensation circuit comprising:
a voltage sensor, one terminal of the voltage sensor being coupled to the emitting device driving unit and the emitting device, for sensing a voltage of the emitting device and sending out a signal according to the voltage; and
a compensation unit, coupled to the voltage sensor and the emitting device driving unit, for receiving the signal output from the voltage sensor and outputting a compensation signal to the emitting device driving unit according to the signal.

13. The compensation circuit of a pixel of an active organic electro-luminescence device of claim 12, wherein the voltage sensor comprises a transistor, the transistor comprises a gate, a drain and a source, the gate is coupled to the emitting device driving unit and the emitting device, a voltage is applied to the drain, and the source is coupled to the compensation unit.

14. The compensation circuit of a pixel of an active organic electro-luminescence device of claim 12, wherein the voltage sensor comprises a transistor, the transistor comprises a gate, a drain and a source, the gate is coupled to the emitting device driving unit and the emitting device, a voltage is applied to the source, and the drain is coupled to the compensation unit.

15. The compensation circuit of a pixel of an active organic electro-luminescence device of claim 12, wherein the compensation unit comprises:
a memory device, for storing a first driving signal for driving the emitting device; and
a comparison unit, coupled to the memory device and the voltage sensor, for receiving and comparing the first driving signal and the output signal of the voltage sensor and sending out the compensation signal to the emitting device driving unit according to the comparison.

16. The compensation circuit of a pixel of an active organic electro-luminescence device of claim 15, wherein the comparison unit comprises a voltage comparator.

17. The compensation circuit of a pixel of an active organic electro-luminescence device of claim 15, wherein the comparison unit comprises a current comparator.
